(19) United States
(12) Patent Application Publication
(10) Pub. No.: US 2012/0008075 A1
(43) Pub. Date: Jan. 12, 2012

(54) REFLECTION TYPE DISPLAY APPARATUS

(75) Inventors: Seonggyu KWON, Suwon-si (KR); SonUk LEE, Seongnam-si (KR); Sang-Hee JANG, Bucheon-si (KR)

(73) Assignee: SAMSUNG ELECTRONICS CO., LTD., Suwon-si (KR)

(21) Appl. No.: 12/944,237

(22) Filed: Nov. 11, 2010

(30) Foreign Application Priority Data
Jul. 7, 2010 (KR) 10-2010-0065536

(51) Int. Cl. G02F 1/167; G02F 1/1335; G02F 1/157; G02B 5/22

(52) U.S. Cl. 349/108; 359/891; 359/296; 359/267

(57) ABSTRACT

A reflection type display apparatus includes; a first substrate including a plurality of pixel regions, a second substrate disposed substantially opposite to the first substrate, an image display part interposed between the first substrate and the second substrate and which at least one of absorbs and reflects external light therefrom, and a color filter part provided on at least one of the first substrate and the second substrate and including a plurality of color filters corresponding to the plurality of pixel regions in a one-to-one correspondence, wherein each color filter of the plurality of color filters includes a colored part including one color and a white color part including a white color. In one embodiment, the white color part has an area corresponding to a range of about 20% to about 50% or about 75% to about 120% with respect to an area of the colored part.

This application claim priority to Korean Patent Application No. 2010-65536, filed on Jul. 7, 2010, and all the benefits accruing therefrom under 35 U.S.C. §119, the content of which in its entirety is herein incorporated by reference.

### BACKGROUND OF THE INVENTION

1. Field of the Disclosure

The present invention relates to a reflection type display apparatus.

2. Description of the Related Art

Recently, a display apparatus such as a liquid crystal display (“LCD”) or an electrophoretic display has been extensively used in place of a conventional cathode ray tube. The LCD or electrophoretic display apparatus is a non-emissive device and uses an additional light source in order to display an image. Therefore, the LCD or electrophoretic display apparatus is classified into a transmissive display apparatus which displays an image using an embedded backlight as a light source and a reflection type display apparatus which displays an image using natural light as a light source instead of the backlight unit.

However, in the reflection type display apparatus, color reproducibility is degraded when the quantity of ambient light is below a particular threshold.

### BRIEF SUMMARY OF THE INVENTION

The present invention provides a reflection type display apparatus capable of improving display quality.

In one aspect, a reflection type display apparatus includes; a first substrate, a second substrate disposed substantially opposite to the first substrate, an image display part interposed between the first substrate and the second substrates and which at least one of absorbs and reflects external light therefrom, and a color filter part provided on at least one of the first substrate and the second substrate and comprising a plurality of color filters corresponding to the plurality of pixel regions in a one-to-one correspondence, wherein each color filter of the plurality of color filters includes a colored part including one color and a white color part including a white color.

In one exemplary embodiment, the white color part has an area corresponding to a range of about 20% to about 50% of an area of the colored part or about 75% to about 120% of an area of the colored part.

In one exemplary embodiment, the white color part includes a plurality of white sub-filters, and the colored part includes a plurality of colored sub-filters. In one exemplary embodiment, the white sub-filters are alternately arranged with the colored sub-filters in a matrix shape.

In one exemplary embodiment, the color filter part may include a plurality of first regions extending in one of a row direction and a column direction and a plurality of second regions alternately arranged with the first regions. In one exemplary embodiment, the plurality of first regions respectively surround a plurality of regions corresponding to an edge of each pixel region of the plurality of pixel regions and a plurality of second regions respectively surrounded by the plurality of first regions.

In one exemplary embodiment, the plurality of first regions constitute the white color part, and the plurality of second regions include the white sub-filters and the colored sub-filters alternately arranged with each other in a form of a matrix.

In one exemplary embodiment, the color filters may be sequentially arranged in at least one of column and row directions in such a manner that adjacent color filters include different colors.

In one exemplary embodiment, the image display part includes a first electrode disposed on the first substrate, a second electrode disposed on the second substrate, and an image display layer interposed between the first electrode and the second electrodes and driven by an electric field between the first electrode and the second electrodes.

In one exemplary embodiment, the image display layer may be an electrophoresis layer, a liquid crystal layer, or an electrochromic layer.

As described above, the reflection type display apparatus according to the embodiment of the present invention displays an image with high brightness and color reproducibility.

### BRIEF DESCRIPTION OF THE DRAWINGS

The above and other advantages of the present invention will become readily apparent by reference to the following detailed description when considered in conjunction with the accompanying drawings wherein:

FIG. 1 is a top plan view showing a first exemplary embodiment of a reflection type display apparatus according to the present invention;

FIG. 2 is a cross-sectional view taken along line I-I′ of FIG. 1;

FIG. 3 is a top plan view showing one color filter corresponding to one pixel region in the first exemplary embodiment of a reflection type display apparatus according to the present invention;

FIG. 4 is a top plan view showing color filters of FIG. 3 which are arranged in pixel regions;

FIGS. 5A to 5C are graphs showing a reflection rate as a function of a wavelength of light passing through a color filter;

FIG. 6 is a graph representing a color interference rate when the area of a white color part varies with respect to the area of a colored part;

FIG. 7 is a graph representing a color interference rate when the area of a white color part varies with respect to the area of a colored part, and when the white color part is omitted;

FIG. 8 is a graph representing both of color reproducibility and brightness when the area of a white color part is different from the area of a colored part;

FIG. 9 is a top plan view showing the arrangement of color filters in a second exemplary embodiment of a reflection type display apparatus according to the present invention;

FIG. 10 is a top plan view showing one color filter corresponding to one pixel region in a third exemplary embodiment of a reflection type display apparatus according to the present invention;

FIG. 11 is a graph representing a color distortion rate when the area of a white color part varies with respect to the area of a white color part in the same manner as that of FIG. 7 in the third exemplary embodiment of a reflection type display apparatus according to the present invention;

FIG. 12 is a top plan view showing one color filter corresponding to one pixel region in a fourth exemplary embodiment of a reflection type display apparatus according to the present invention;

FIG. 13 is a cross-sectional view showing a portion of a fifth exemplary embodiment of a reflection type display apparatus according to the present invention;

FIG. 14 is a cross-sectional view showing a portion of a sixth exemplary embodiment of a reflection type display apparatus according to the present invention;

FIG. 15 is a cross-sectional view showing a portion of a seventh exemplary embodiment of a reflection type display apparatus according to the present invention; and

FIG. 16 is a cross-sectional view showing a portion of an eight exemplary embodiment of a reflection type display apparatus according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

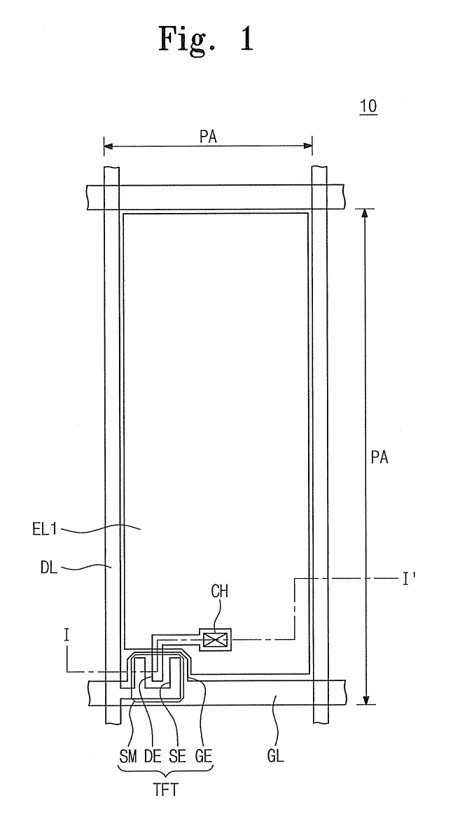

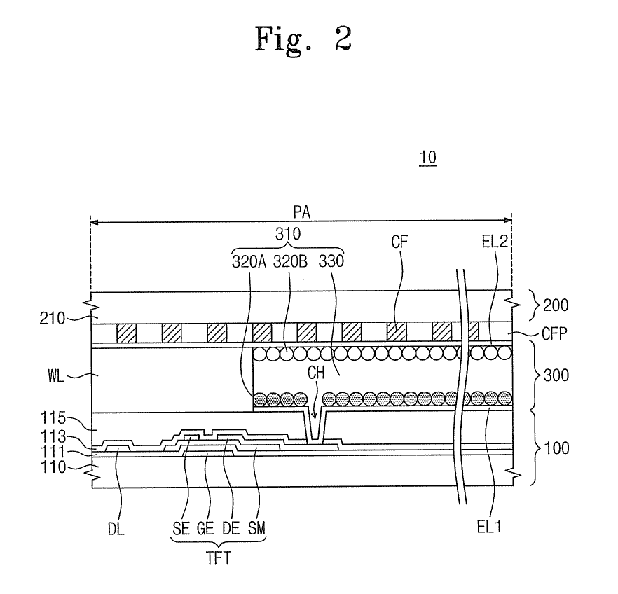

FIG. 1 is a top plan view showing a first exemplary embodiment of a reflection type display apparatus according to the present invention, and FIG. 2 is a cross-sectional view taken along line I-I′ of FIG. 1.

Referring to FIGS. 1 and 2, the reflection type display apparatus includes a first substrate 100, a second substrate 200, an image display part 300, and a color filter part CFP.

In the first exemplary embodiment, the first substrate 100 is provided with the color filter part CFP, but the present invention is not limited thereto. In other embodiments, the second substrate 200 may be provided with the color filter part CFP.

The first substrate 100 includes a plurality of pixel regions PA. As illustrated in the exemplary embodiment of FIG. 1, the pixel regions PA may be substantially rectangular as viewed from a top plan view; however, alternative configurations include embodiments wherein the pixel regions PA have different shapes. The first substrate 100 includes a first insulating substrate 110, gate lines GL, data lines DL, and thin film transistors TFT.

Although only one pixel region PA is shown in FIGS. 1 and 2, the pixel regions PA in the display apparatus are actually arranged in a matrix shape having a plurality of columns and a plurality of rows. Hereinafter, since the pixel regions PA have substantially the same structure, only one pixel region PA will be described for the purpose of explanation. Although the pixel region PA has a rectangular shape extending in one direction, the present invention is not limited thereto. In other words, the shape of the pixel region PA may have various modifications such as a V shape or a Z shape as briefly discussed above.

As illustrated in the exemplary embodiment of FIG. 1, each pixel region PA of the first insulating substrate 110 includes the gate line GL, the data line DL, and the thin film transistor TFT. The gate line GL extends in one direction on the first insulating substrate 110. The data line DL crosses the gate line GL on the first insulating substrate 110 in such a manner that the data line DL is insulated from the gate line GL. In the present exemplary embodiment, the data line extends in a second direction substantially perpendicular to the first direction.

The thin film transistor TFT is adjacent to the intersection between the gate line GL and the data line DL. The thin film transistor TFT includes a gate electrode GE branching from the gate line GL, a source electrode SE branching from the data line DL, and a drain electrode DE spaced apart from the source electrode SE.

Hereinafter, a cross-sectional view of the first substrate 100 will be described with reference to FIG. 2. The gate line GL and the gate electrode GE are provided on the first insulating substrate 110 in the pixel region PA.

A semiconductor pattern SM is provided on the gate line GL while interposing the first insulating layer 111 between the semiconductor pattern SM and the gate line GL.

The data line DL, the source electrode SE, and the drain electrode DE are provided on the first insulating substrate 110 having the semiconductor pattern SM provided thereon. The semiconductor pattern SM forms a selectively conductive channel between the source electrode SE and the drain electrode DE.

The second insulating layer 113 is provided on the source electrode SE and the drain electrode DE provided on the first insulating layer 111. A passivation layer 115 is provided on the second insulating layer 113.

The second substrate 200 is provided in substantial opposition to the first substrate 100; that is, in one exemplary embodiment they are disposed opposite to one another. The second substrate 200 includes a second insulating substrate 210.

The image display part 300 is interposed between the first and second substrates 100 and 200. The image display part 300 absorbs or reflects external light to display an image.

The image display part 300 includes a first electrode EL1, a second electrode EL2, and an image display layer. The first electrode EL1 corresponds to the pixel region PA in a one-to-one correspondence and is formed on the first substrate 100. That is, the display apparatus may include a plurality of first electrodes, wherein a single first electrode (also referred to as a first sub-electrode) is formed in a single pixel region PA. The first electrode EL1 is provided on the passivation layer 115. The first electrode EL1 may include a metallic reflective material such that external light is reflected thereby. Although not shown, exemplary embodiments include configurations wherein the first electrode EL1 may be provided in multiple layers such as a double layer or a triple layer including a conductive material. If the first electrode EL1 is formed in the multiple layers, at least one of the multiple layers may include a metallic reflective material such that external light is reflected therefrom. In addition, a reflective layer may be additionally formed at a lower portion or an upper portion of the first electrode EL1 while overlapping with at least a portion of the first electrode EL1 such that external light can be reflected therefrom. The first electrode EL1 is electrically connected to the drain electrode DE through a contact hole CH passing through the second insulating layer 113 and the passivation layer 115.

The second electrode EL2 is formed on the second insulating substrate 210. The second electrode EL2 receives a common voltage and forms an electric field between the first and second electrodes EL1 and EL2 together with the first electrode EL1. In one exemplary embodiment, the second electrode EL2 includes a transparent material on the second insulating substrate 210.

As shown in the exemplary embodiment of FIG. 2, the second electrode EL2 is provided as a single unit, but the present invention is not limited thereto. For example, alternative exemplary embodiments include configurations wherein a plurality of second electrodes (also referred to as second sub-electrodes) is provided to receive additional voltage. If a plurality of second electrodes EL2 is provided, the second electrodes EL2 may correspond to the first electrode EL1 in a one-to-one correspondence or in a one-to-many correspondence. For example, in one exemplary embodiment one first electrode EL1 and two second electrodes EL2 may be provided within a region corresponding to one pixel region PA. In such an exemplary embodiment, the first electrode EL1 and the two second electrodes EL2 are individually driven such that the image display layer can be adjusted. In particular, the first and second electrodes EL1 and EL2 are individually driven such that the area of the image display layer can be adjusted.

The image display layer is controlled by an electric field to display an image. For example, the image display layer may be an electrophoresis layer, a liquid crystal layer, an electrochromic layer or various other similar layers. An exemplary embodiment in which the image display layer is an electrophoresis layer 310 will be described below as one example.

A partition WL may be provided in the image display part 300. Exemplary embodiments of the partition WL may include an organic insulating material or an inorganic insulating material. Exemplary embodiments include configurations wherein the partition WL may be prepared in a multiple layer including an organic insulating material and an inorganic insulating material. The partition WL may divide an electrophoresis layer 310 corresponding to the pixel regions PA. The partition WL may individually surround each pixel region PA or all of the pixel regions PA.

The electrophoresis layer 310 includes an insulating medium 330 and charged particles 320A and 320B. The insulating medium 330 corresponds to a dispersion medium in a dispersion system in which the charged particles are dispersed. The charged particles include an electrophoretic material and are dispersed in the insulating medium 330. According to the present exemplary embodiment, the charged particles include white charged particles 320A and colored charged particles 320B. In one exemplary embodiment, the colored charged particles 320B may have a black color. The white charged particles 320B have charges such that the polarity thereof is different from that of charges of the color charged particles 320B. In one exemplary embodiment, the polarity of the white charged particles 320B and the color charged particles 320B may be substantially opposite to one another.

Although the charged particles 320A and 320B include the white charged particles 320A and the colored charged particles 320B according to the present exemplary embodiment, the present invention is not limited thereto. According to another exemplary embodiment of the present invention, the charged particles 320A and 320B may have one kind of color charged particles. In such an alternative exemplary embodiment, one kind of color charged particles may be black charged particles. In such an exemplary embodiment, the insulating medium 330 may have a white color, the first electrode EL1 may include a reflective material, and a reflective layer (not shown) may be further provided at an upper portion or a lower portion of the first electrode EL1. Correspondingly, a white color can be realized by the insulating medium 330, the first electrode EL1, or the reflective layer.

The color filter part CFP is provided on one of the first and second substrates 100 and 200. For example, in the exemplary embodiment as shown in FIG. 2, the color filter part CFP may be formed on the second substrate 200, that is, the color filter part CFP may be interposed between the second insulating substrate 210 and the second electrode EL2. Although not shown, if the color filter part CFP is formed on the first substrate 100, the color filter part CFP may be interposed between the first insulating substrate 110 and the first electrode EL1.

The color filter part CFP filters external light to represent a color. The color filter part CFP includes a plurality of color filters CF corresponding to the pixel regions PA in a one-to-one correspondence. Each color filter CF individually represents one color. Accordingly, external light incident onto the color filter CF corresponding to each pixel region PA may be absorbed or reflected by the color filter CF to represent one color. In the present exemplary embodiment, the color filters CF represent one of a red color, a green color, and a blue color. The color filters CF representing the red, green, and blue are designated by red, green, and blue color filters R, G, and B. Alternative exemplary embodiments may include alternative configurations of the color filters CF, e.g., the color filters may include cyan, magenta and yellow. Details of the color filter part CFP will be discussed in more detail below.

If the thin film transistor TFT is turned on in response to a driving signal supplied through the gate line GL in the reflection type display apparatus having the above-described structure, an image signal supplied through the data line DL is provided to the first electrode EL1 through the thin film transistor TFT that has been turned on. Accordingly, an electric field is formed between the first electrode EL1 and the second electrode EL2, wherein the second electrode EL2 has received the common voltage. Charged particles 320A and 320B of the electrophoresis layer 310 move within the image display part 300 respectively according to the electric field orientation, so that external light incident onto the electrophoresis layer 310 is absorbed or reflected by the charged particles 320A and 320B to display an image.

In more detail, the external light is incident toward the electrophoresis layer 310 through the second insulating substrate 210. The external light reaches the electrophoresis layer 310 through the color filter part CFP. If the white color charged particles 320B of the electrophoresis layer 310 are arranged at the top side of the second electrode EL2 by the electric field, most, e.g., a substantial majority, of the external light is reflected by the electrophoresis layer 310, sequentially passes through the color filter part CFP and the second insulating substrate 210, and exits to the outside, such that the external light can be perceived as colored light by a user. If the colored charged particles 320A of the electrophoresis layer 310 are arranged at the top side of the second electrode EL2 by the electric field, most external light is absorbed by the electrophoresis layer 310, so that a colored image is viewed by the naked eye of the user (if the color of the colored charged particles 320A is black, a black colored image is recognized by the user).

As described above, the charged particles 320A and 320B of the electrophoresis layer 310 move in the insulating medium 330 by the electric field to display an image. The movement of the charged particles 320A and 320B in the insulating medium 330 can be controlled by the separation distance between the first and second electrodes EL1 and EL2, the intensity of voltage applied between two electrodes EL1 and EL2, the offset of the voltage, and the frequency of the voltage application.

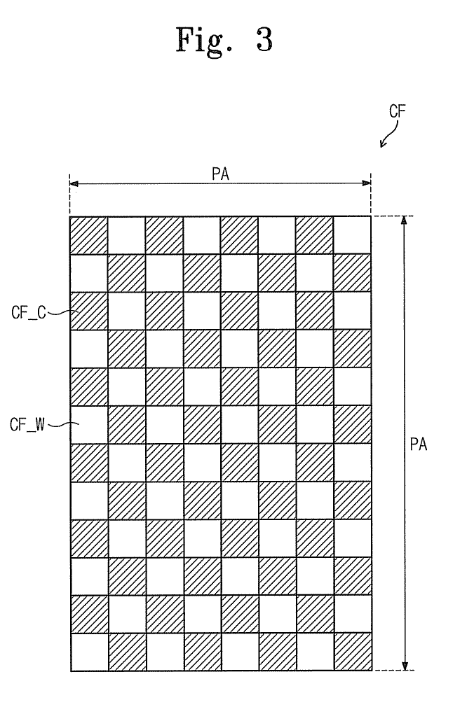

FIG. 3 is a top plan view showing one exemplary embodiment of a color filter CF corresponding to one pixel region PA in the color filter part CFP according to the first exemplary embodiment of the present invention. Hereinafter, an exemplary embodiment in which the color filter CF is a red color filter R will be described. Details of the green and blue color filters G and B are omitted in order to avoid redundancy, and the structure of the green and blue color filters G and B is regarded as substantially identical to that of the red color filter R except for a color of the color filter CF thereof unless otherwise specifically described.

The color filter CF includes a white color part and a colored part.

The white color part represents a white color. External light reaching the white color part is reflected so that the external light is recognized as white light by the eye of a user. Most wavelengths of the external light reaching the white color part are reflected, while a small minority of wavelength, substantially inconsequential to user perception, may be absorbed.

The colored part represents a specific color such as red, green, or blue. Wavelengths of the external light reaching the colored part are both absorbed and reflected so that the external light is recognized as colored light by the eye of a user. That is, in the colored part, a specific wavelength of the external light is more readily absorbed or reflected than remaining wavelengths of the external light, so that the external light reflected from the colored part is perceived as colored light by the ye of the user as described above. Specifically, in an example where the colored part is a portion of a green color filter, the colored part absorbs wavelengths outside of the wavelength range of a green color, e.g., it absorbs wavelengths shorter than about 490 nm and greater than about 560 nm, and reflects wavelengths within the prescribed range.

The white color part includes a plurality of white sub-filters CF_W (also referred to as white color sub-filters). The colored part includes a plurality of colored sub-filters CF_C. The colored sub-filters CF_C arranged in the color filter CF corresponding to one pixel region PA represent one of red, green, and blue, and the color of the color filter CF is determined depending on the color of the colored sub-filters CF_C.

Exemplary embodiments include configurations wherein the white sub-filters CF_W and the colored sub-filters CF_C may have various shapes. The white sub-filters CF_W and the colored sub-filters CF_C may be provided in a rectangular shape, but the present invention is not limited thereto. For example, alternative exemplary embodiments include configurations wherein the white sub-filters CF_W and the colored sub-filters CF_C may be provided in a circular shape or a polygonal shape. Exemplary embodiments include configurations wherein the white sub-filters CF_W and the colored sub-filters CF_C may have the same size or shape, but the present invention is not limited thereto. In other words, the white sub-filters CF_W and the colored sub-filters CF_C may have different sizes or shapes. Exemplary embodiments include configurations wherein when viewed from a plan view, the white sub-filters CF_W and the colored sub-filters CF_C do not overlap with each other, but the present invention is not limited thereto. For example, in one exemplary embodiment the edges of the colored sub-filters CF_C may overlap with each other when viewed from a plan view in order to adjust the comparative areas of the white sub-filters CF_W and the colored sub-filters CF_C.

The white sub-filters CF_W and the colored sub-filters CF_C are uniformly arranged throughout the whole region corresponding to the pixel region PA to present uniform brightness and uniform color reproducibility. For example, as shown in FIG. 3, the white sub-filters CF_W and the colored sub-filters CF_C may be alternately arranged with each other in a matrix shape.

In one exemplary embodiment, the white sub-filters CF_W and the colored sub-filters CF_C may be formed through a photolithography process. If the white sub-filters CF_W and the colored sub-filters CF_C are formed through the photolithography process, the shortest width of each sub-filter may be about 15 μm or more. In detail, since the shape of the sub-filters may be changed due to the interference of light, when a photoresist is exposed in the photolithography process, the shortest width of each sub-filter may be set to about 15 μm or more by taking into consideration a process margin to compensate for deformation/interference caused by the interference of light. In order to satisfy both desired brightness and color reproducibility characteristics, the white color part has an area corresponding to about 20% to about 50% of the area of the colored part, or about 75% to about 120% of the area of the colored part. That is, if the area of the white color part is less than 20% of the area of the colored part, superior color reproducibility can be represented, but the reflective rate of the external light is low, so that the brightness of the reflection type display apparatus becomes correspondingly lowered. In general, if the brightness of the reflection type display apparatus becomes lowered, a distorted color may be perceived by a user, e.g., a shade of the color is misrepresented. The color distortion phenomenon is similar to a phenomenon in which red and blue colors are recognized as being a same color in a dark environment. However, if the area of the white color part is greater than about 50% of the area of the colored part, the reflective rate may be increased while the color reproducibility is lowered.

If the area of the white color part is within the range of about 75% to about 120% of the area of the colored part, color reproducibility may be inferior to color reproducibility represented when the area of the white color part is within the range of about 20% to about 50% of the area of the colored part, but higher brightness is represented to compensate for the reduction of the color reproducibility. If the area of the white color part is greater than or equal to about 120% of the area of the colored part, the color reproducibility may be excessively lowered, and the brightness may be not strong enough to compensate for the color reproducibility, so that display quality may be degraded, e.g., the colors appear washed-out.

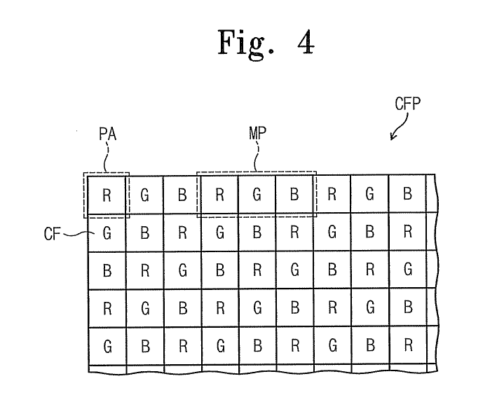

FIG. 4 is a top plan view showing an exemplary embodiment of how the color filters CF of FIG. 3 are arranged in the pixel regions PA. The color filters CF may be arranged in a column direction, a row direction, or both column and row directions in such a manner that adjacent color filters CF represent different colors. If the red, green, and blue color filters R, G, and B constitute one pixel unit MP (also referred to as unit pixels), pixel units MP may be repeatedly arranged in the column direction, the row direction, or both column and row directions in the color filter part CFP.

The white sub-filters CF_W and the colored sub-filters CF_C may have various sizes, and in one exemplary embodiment the sub-filters are not visible to the naked eyes of the user. It may be undesirable for the individual white sub-filters CF_W and colored sub-filters CF_C to be perceivable by a user. To prevent the sub-filters CF_W and CF_C from being visible to the naked eyes of the user, the white sub-filters CF_W and colored sub-filters CF_C are configured to have a small size.

According to exemplary embodiments of the present invention, the area of the white color part can be adjusted such that a color interference rate is lowered. The color interference rate refers to a value obtained by dividing the sum of reflective rates of an external region by a reflective rate of a color region when a wavelength region representing a specific color in a graph showing a reflective rate as a function of a wavelength in a visible ray band is designated to the color region, and a wavelength region that does not represent a specific color is designated to the external region. As the reflective rate of a wavelength representing a specific color is increased, a color can be more vividly represented and perceived by a user. Accordingly, as the color interference rate is reduced, the color reproducibility is enhanced.

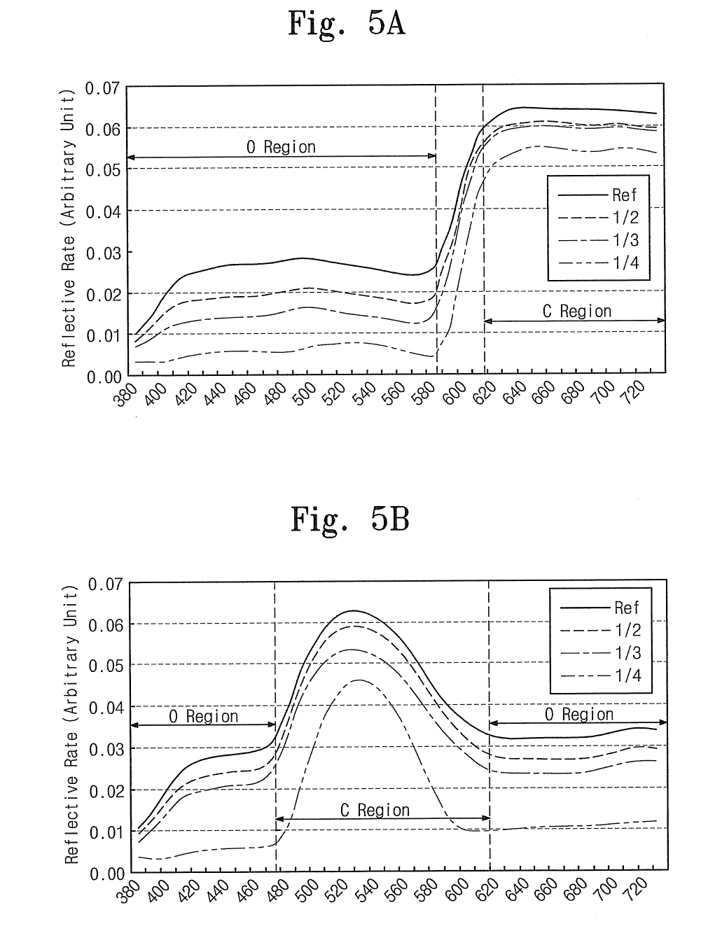

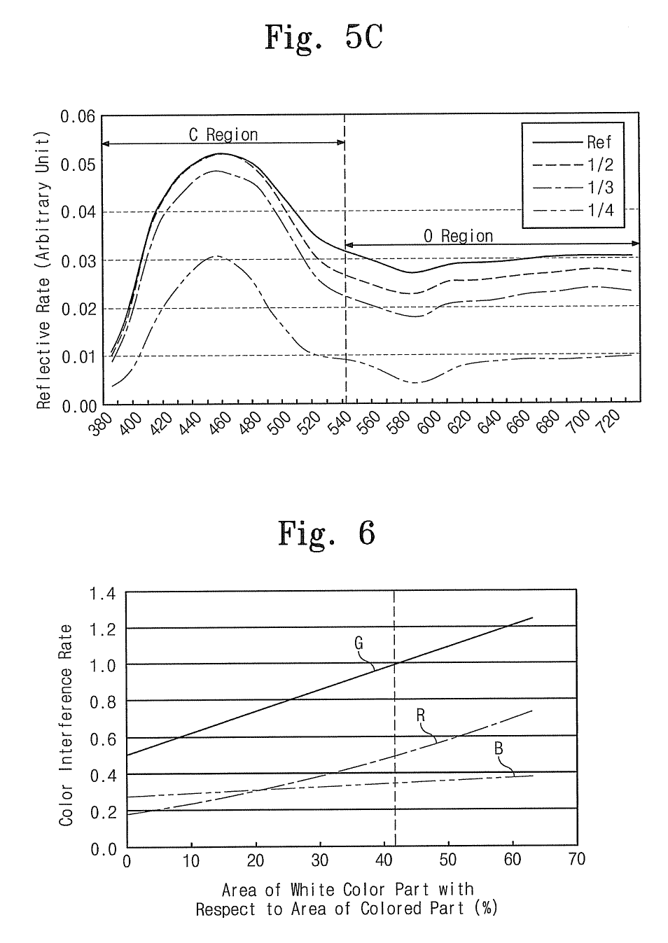

FIGS. 5A to 5C are graphs showing a reflective rate as a function of a wavelength of light passing through the color filter CF when the color filter CF is used. FIGS. 5A to 5C represent the reflective rate as a function of a wavelength of light passing through the color filter CF when the white color part is not present (as referred to as “Ref”), and embodiments wherein the area of the white color part corresponds to ½, ⅓, or ¼ of the area of the colored part.

FIG. 5A is a graph representing a reflective rate as a function of a wavelength of transmitted light when the red color filter R is used. FIG. 5B is a graph representing a reflective rate as a function of a wavelength of transmitted light when the green color filter G is used. FIG. 5C is a graph representing a reflective rate as a function of a wavelength of transmitted light when the blue color filter B is used. In the graphs of FIGS. 5A to 5C, the color region corresponds to a wavelength region representing a red color, that is, C region, and the external region corresponds to a wavelength region representing colors other than the red color, that is, an O region.

FIG. 6 is a graph representing a color interference rate when the area of the white color part varies with respect to the area of the colored part. The result value, that is, the color reference rate, in the graph of FIG. 6 is obtained by calculating the reflective rate in each wavelength in the same manner as that of FIGS. 5A to 5C.

Referring to FIGS. 5A to 5C, and FIG. 6, as the area of the white color part with respect to the area of the colored part is reduced, a color interference rate is reduced. Accordingly, as the area of the white color part is reduced, the color reproducibility is enhanced.

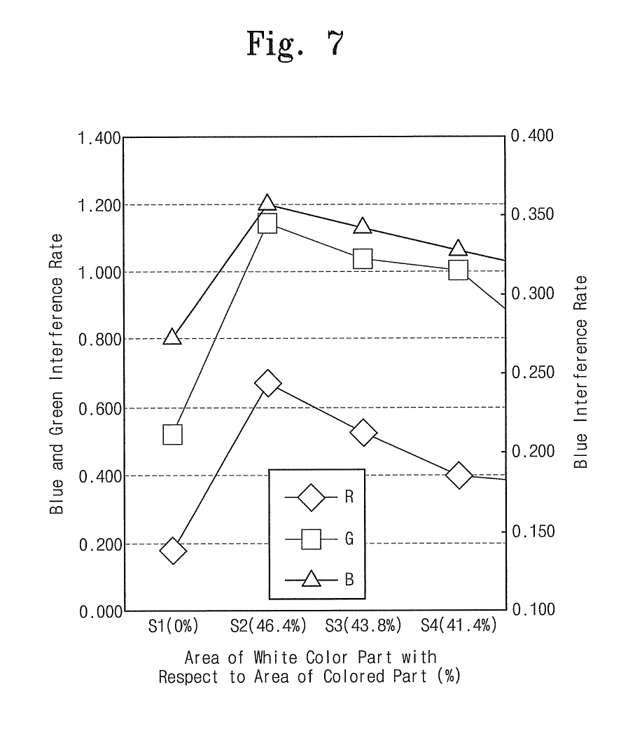

FIG. 7 is a graph representing a color interference rate when the area of the white color part varies with respect to the area of the colored part, and the graph also represents a color reference rate when the white color part is omitted. Referring to FIG. 7, as the area of the white color part with respect to the area of the colored part is reduced, a color distortion rate is substantially reduced. However, when the area of the white color part approaches 0, the reflective rate is significantly lowered as compared with a case in which the white color part is present. Therefore, when the color filter part CFP includes only the colored part, the quantity of reflected light is less, so that the reflection type display apparatus is perceived as being very dark by a user. Accordingly, even if the color interference rate is less, since brightness is low, a color distortion rate is undesirably increased.

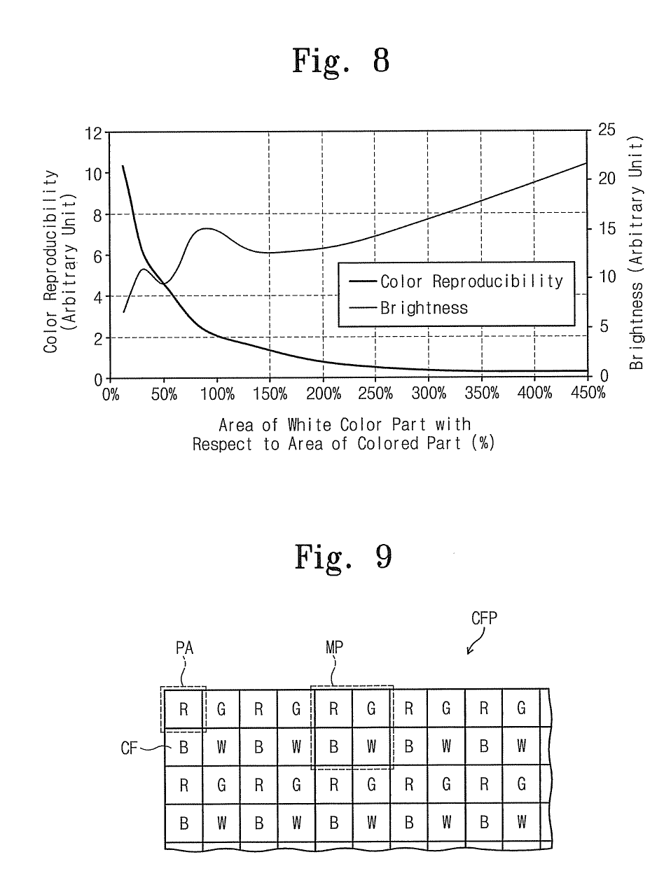

FIG. 8 is a graph representing both of the color reproducibility and the brightness when the area of the white color part is different from the area of the colored part. In FIG. 7, an X axis represents the ratio of the area of the white color part to the area of the colored part, and a Y axis represents the color reproducibility and the brightness in an arbitrary unit.

Referring to FIG. 8, as the ratio of the area of the white color part to the area of the colored part is increased, the color reproducibility is degraded. This result is identical to the results of FIGS. 5A to 5C, and FIG. 6. In contrast, the brightness may be increased as the ratio of the area of the white color part to the area of the colored part is increased. However, a gradient is nonlinear. In other words, in a specific region, the brightness is increased when the color reproducibility is decreased. In particular, when the ratio of the area of the white color part to the area of the colored part is in the range of about 20% to about 50%, and again in a range of about 75% to about 120%, high brightness and good color reproducibility is represented. Relatively higher brightness is represented in the specific region as compared with other regions. Therefore, the increase of the brightness can compensate for the quality degradation of the reflection type display apparatus caused by the reduction of the color reproducibility.

As described above, the reflection type display apparatus according to the embodiment of the present invention displays an image having higher brightness and higher color reproducibility as compared with those of the conventional reflection type display apparatus.

Hereinafter, the conventional reflection type display apparatus will be briefly described for comparison only. In the conventional reflection type display apparatus, a hole is formed inside the color filters (the hole is mostly filled with a transparent material) to enhance brightness. However, light passing through the hole is reflected in an image display part and forwarded through the hole again. Accordingly, the light is absorbed, reflected, and scattered by the color filter, the image display part around the hole, and a transparent material filled in the hole. Therefore, the conventional reflection type display apparatus represents lower color reproducibility as well as lower brightness as compared to the present invention. In contrast, since a portion of external light is directly reflected by the white color part without passing through the color filters in the reflection type display apparatus according to the exemplary embodiments of the present invention, the reflection type display apparatuses according to the embodiment of the present invention represent higher brightness and higher color reproducibility.

Hereinafter, second to eighth exemplary embodiments of reflection type display apparatuses according to the present invention will be described while focusing on the difference from the first exemplary embodiment to avoid redundancy. In addition, components that have been described in the first exemplary embodiment will be omitted and the same reference numerals will be used to designate the same components.

FIG. 9 is a top plan view showing the arrangement of color filters in the second exemplary embodiment of a reflection type display apparatus according to the present invention.

Referring to FIG. 9, in the second exemplary embodiment of a reflection type display apparatus according to the present invention, a white color is added to the colored part of each color filter CF, similar to the first exemplary embodiment. In the second exemplary embodiment of a reflection type display apparatus according to the present invention, the color filter part CFP includes a red color filter R, a green color filter G, a blue color filter B, and a white color filter W. Therefore, the color of the colored part in the white color filter W corresponds to a white color, so that the pixel region PA corresponding to a region of the white color filter W wholly represents a white color.

The color filters CF may be arranged in a column direction, a row direction, or both column and row directions in such a manner that adjacent color filters CF in the column direction or in the row direction or in both column and row directions represent different colors. When the red, green, blue, and white color filters R, G, B, and W constitute one pixel unit MP, pixel units MP may be repeatedly arranged in the column direction, the row direction, or both column and row directions in the color filter part CFP.

The white color filter W is used to increase the reflection effect of the white color part. Since white color filters W are substantially uniformly arranged in the whole pixel regions PA, the brightness is significantly increased by the white color filters W.

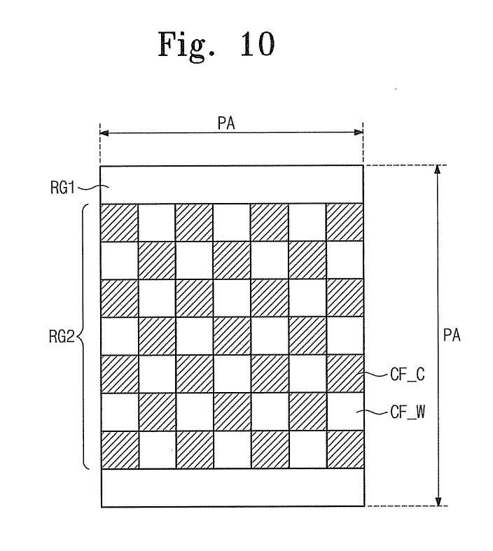

FIG. 10 is a top plan view showing one color filter CF corresponding to one pixel region PA in the third exemplary embodiment of a reflection type display apparatus according to the present invention.

Referring to FIG. 10, the color filter part CFP includes a plurality of first regions RG1 and a plurality of second regions RG2. The first regions RG1 may extend in a row or column direction. FIG. 10 shows that the first regions RG1 extend in the row direction. The second regions RG2 are alternately arranged with the first regions RG1.

The first regions RG1 constitute the white color part. A portion of the second regions RG2 constitute the white color part, and other portions of the second regions RG2 constitute the colored part. In other words, the second regions RG2 include the white sub-filters CF W and the colored sub-filters CF_C, and the white sub-filters CF_W and the colored sub-filters CF_C are alternately arranged with each other in a matrix shape.

The first regions RG1 are used to increase the reflection effect of the white color part. However, differently from the first exemplary embodiment, the brightness increase effect due to the first regions RG1 is more strongly represented in the third exemplary embodiment.

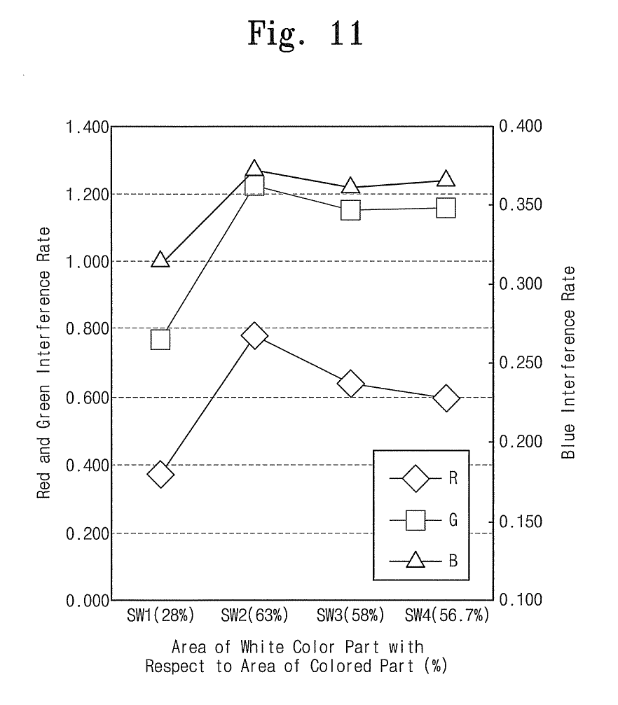

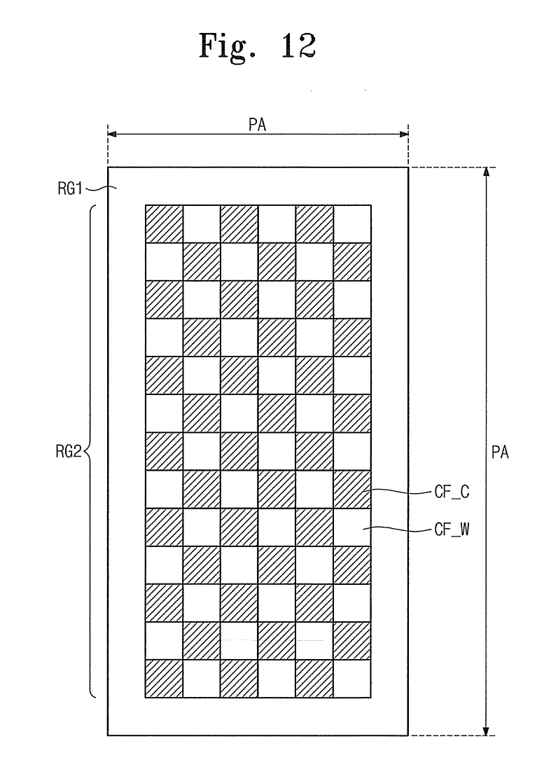

FIG. 11 is a graph representing a color distortion rate when the area of the white color part varies with respect to the area of the white color part in the same manner as that of FIG. 7 in the third exemplary embodiment of a reflection type display apparatus according to the present invention, and also representing a color distortion rate when the white color part is omitted. Referring to FIG. 11, since the area of the white color part according to the second exemplary embodiment of the present invention is greater than the area of the white color part according to the first exemplary embodiment of the present invention, the color distortion rate according to the third exemplary embodiment is greater than the color distortion rate according to the first exemplary embodiment. However, remaining results may be substantially identical to the result according to the first exemplary embodiment. In other words, as the area of the white color with respect to the area of the colored part is reduced, the color distortion rate is reduced. When the area of the white color part is 0, the reflective rate is significantly low as compared with that of a case in which the white color part is present.

However, the brightness according to the area of the white color part, even in the third exemplary embodiment, must be taken into consideration. The brightness according to the area of the white color part is substantially the same as that disclosed in FIG. 8. Therefore, in the third exemplary embodiment of the present invention, the color filter part CFP includes the first and second regions RG1 and RG2, and the area of the white color part is adjusted to a value similar to that of the first exemplary embodiment, thereby enhancing display quality.

FIG. 12 is a top plan view showing one color filter CF corresponding to one pixel region PA in the fourth exemplary embodiment of a reflection type display apparatus according to the present invention.

Referring to FIG. 12, the color filter part CFP includes a plurality of first regions RG1 and a plurality of second regions RG2.

The first regions RG1 correspond to edges of the pixel regions PA. The first regions RG1 may overlap with a region of the gate lines GL and the data lines DL on the first substrate 100. Thus, first region RG1 effectively covers regions of the gate line GL and the data line DL where an image is not formed.

The second regions RG2 are surrounded by the first regions RG1. The first regions RG1 constitute the white color part, a portion of the second regions RG2 constitute the white color part, and other portions of the second regions RG2 constitute the colored part. In other words, the second regions RG2 include the white sub-filters CF_W and the colored sub-filters CF_C, and the white sub-filters CF_W and colored sub-filters CF_C are alternately arranged with each other in the form of a matrix.

Similarly to that of the third exemplary embodiment, the first regions RG1 are used to increase a reflection effect of the white color part using a part where the partition WL is formed.

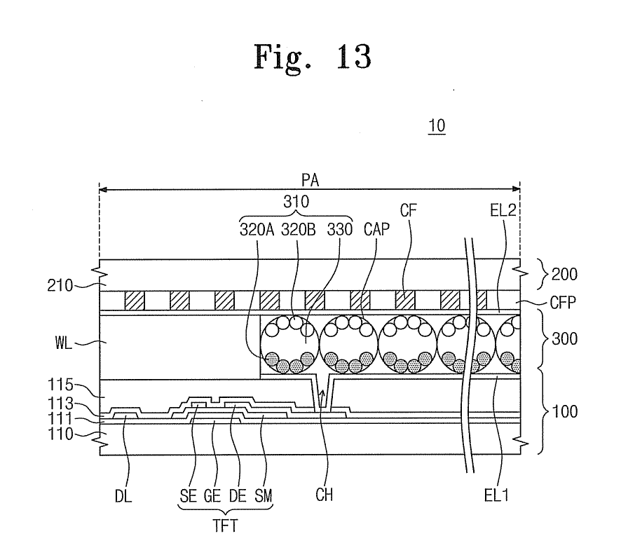

FIG. 13 is a cross-sectional view showing the fifth exemplary embodiment of a reflection type display apparatus according to the present invention.

Referring to FIG. 13, in the fifth exemplary embodiment of a reflection type display apparatus according to the present invention, the electrophoresis layer 310 includes a plurality of capsules CAP arranged in a space formed by the first electrode EL1, the second electrode EL2, and the partition WL. Each capsule CAP includes the charged particles 320A and 320B, and the insulating medium 330 in which the charged particles 320A and 320B are dispersed. The charged particles 320A and 320B may include at least one of the white charged particles 320B and the black charged particles 320A as discussed above.

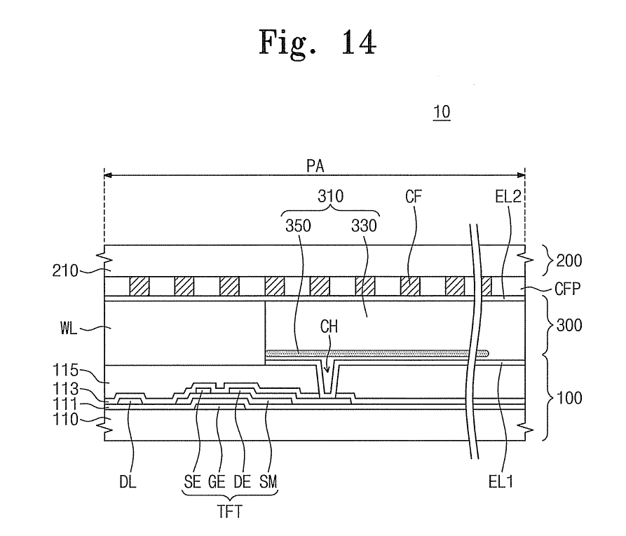

FIG. 14 is a cross-sectional view showing a portion of the sixth exemplary embodiment of a reflection type display apparatus according to the present invention.

Referring to FIG. 14, in the sixth exemplary embodiment of a reflection type display apparatus according to the present invention, the electrophoresis layer 310 includes an electrophoretic emulsion provided in a space formed by the first electrode EL1, the second electrode EL2, and the partition WL. In the present exemplary embodiment, the electrophoretic emulsion includes a continuous phase non-polar solvent 350, and droplets of a polar solvent 340 dispersed in the non-polar solvent 350, wherein the droplets are controlled by an electric field formed by the first and second electrodes EL1 and EL2.

The polar solvent 340 contains dyes dissolved therein and not dissolved in the non-polar solvent 350, thereby representing a black color or a white color.

The electric field supplies energy such that the polar solvent 340 moves and is condensed, rather than the non-polar solvent 350. The polar solvent 340 has predetermined charges, and moves toward an adjacent opposite electrode with charges having an opposite polarity to the polarity of the charges of the non-polar solvent 350 when the electric field is applied.

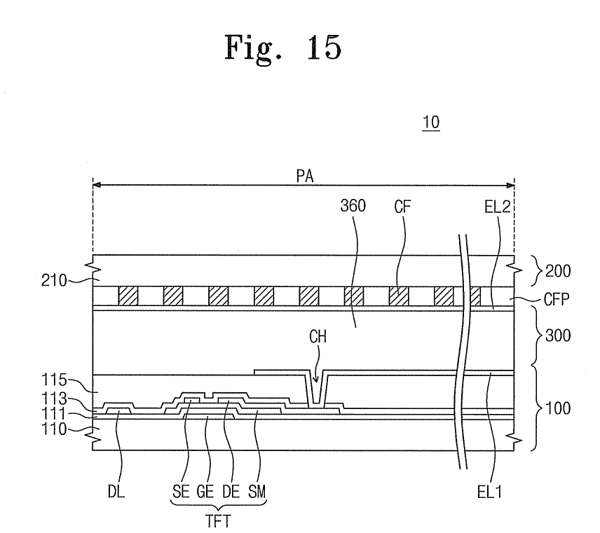

FIG. 15 is a cross-sectional view showing a portion of the seventh exemplary embodiment of a reflection type display apparatus according to the present invention.

Referring to FIG. 15, in the seventh exemplary embodiment of a reflection type display apparatus according to the present invention, the image display layer is an electrochromic layer 360.

In the electrochromic layer 360, the degree of a redox reaction varies depending on applied voltage, and the transparency of the electrochromic layer 360 is adjusted according to the degree, e.g., a magnitude, of the redox reaction. An image can be displayed by adjusting voltage applied to the first and second electrodes EL1 and EL2.

The electrochromic layer 360 may include at least one inorganic compound selected from the group consisting of tungsten trioxide (WO₃), molybdenum oxide (MoO₃), and iridium oxide (IrOx) or other materials with similar characteristics, and at least one organic compound selected from the group consisting of bioregen, rare earth phthalocyanine, and styryl or other materials with similar characteristics. In addition, the electrochromic layer 360 may include at least one conductive polymer selected from the group consisting of poly pirrole, poly thiophene, and polyaniline or other materials with similar characteristics. The electrochromic compound material may include a plurality of materials, or may represent a black color in order to increase color saturation according to the desired application.

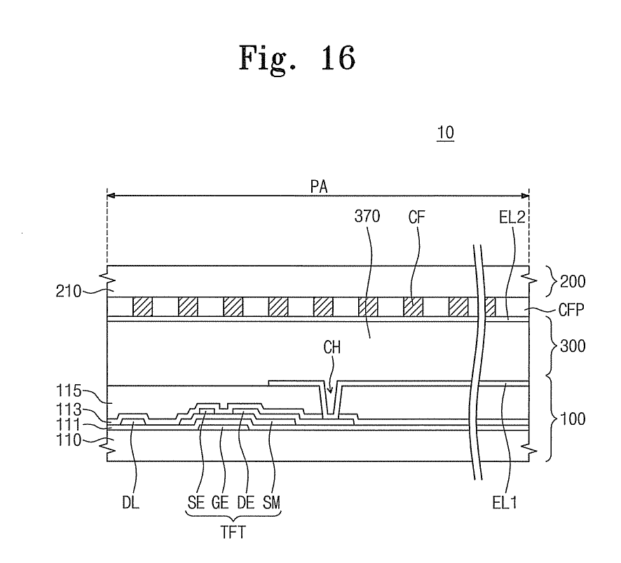

FIG. 16 is a cross-sectional view showing a portion of the eighth exemplary embodiment of a reflection type display apparatus according to the present invention.

Referring to FIG. 16, in the eighth exemplary embodiment of a reflection type display apparatus according to the present invention, the image display layer is a liquid crystal layer 370.

The liquid crystal layer 370 includes liquid crystal molecules. The alignment of the liquid crystal molecules varies depending on an applied electric field formed by the electrodes EL1 and EL2. Accordingly, the quantity of light passing through the liquid crystal layer 370 is adjusted to display an image. Exemplary embodiments include configurations wherein the liquid crystal layer 380 may be a cholesteric liquid crystal layer to reflect external light that is incident thereto.

Although the exemplary embodiments of the present invention have been described above, it is understood that the present invention should not be limited to these exemplary embodiments but various changes and modifications can be made by one ordinary skilled in the art within the spirit and scope of the present invention as hereinafter claimed. For example, although the embodiments have been described in that that the color filters are formed on the second substrate, the present invention is not limited thereto, and the color filters may alternatively be formed on the first substrate. Accordingly, the technical scope of the present invention is not limited to the detailed description of the specification, but determined by accompanying claims.

What is claimed is:

1. A reflection type display apparatus comprising:
a first substrate comprising a plurality of pixel regions;
a second substrate disposed substantially opposite to the first substrate;
an image display part interposed between the first substrate and the second substrate and which at least one of absorbs and reflects external light therefrom; and
a color filter part provided on at least one of the first substrate and the second substrate and comprising a plurality of color filters corresponding to the plurality of pixel regions in a one-to-one correspondence,
wherein each color filter of the plurality of color filters comprises a colored part comprising one color and a white color part comprising a white color.

2. The reflection type display apparatus of claim 1, wherein the white color part has an area of about 20% to about 50% of an area of the colored part or the white color part has an area of about 75% to about 120% of an area of the colored part.

3. The reflection type display apparatus of claim 2, wherein the white color part comprises a plurality of white sub-filters, and the colored part comprises a plurality of colored sub-filters.

4. The reflection type display apparatus of claim 3, wherein the plurality of white sub-filters are alternately arranged with the plurality of colored sub-filters in a matrix shape.

5. The reflection type display apparatus of claim 3, wherein the color filter part comprises:
a plurality of first regions which extend in one of a row direction and a column direction; and
a plurality of second regions alternately arranged with the plurality of first regions,
wherein the first regions constitute the white color part, and the second regions comprise the white sub-filters and the colored sub-filters alternately arranged with each other in a matrix shape.

6. The reflection type display apparatus of claim 3, wherein the color filter part comprises a plurality of first regions respectively surrounding a plurality of regions corresponding to an edge of each pixel region of the plurality of pixel regions and a plurality of second regions respectively surrounded by the plurality of first regions, and
wherein the plurality of first regions constitutes the white part, and the plurality of second regions comprise the white sub-filters and the colored sub-filters alternately arranged with each other in a matrix shape.

7. The reflection type display apparatus of claim 3, wherein each colored part represents one of a red color, a green color and a blue color, the plurality of color filters is sequentially arranged in at least one of a column direction and a row direction so that adjacent color filters comprise different colors.

8. The reflection type display apparatus of claim 3, wherein each colored part represents one of a red color, a green color, a blue color, and a white color, and the plurality of color filters is sequentially arranged in at least one of a column direction and a row directions so that adjacent color filters comprise different colors.

9. The reflection type display apparatus of claim 7, wherein each colored sub-filter has one of a circular shape and a polygonal shape.

10. The reflection type display apparatus of claim 9, wherein each colored sub-filter has a shortest dimension of at least about 15 μm.

11. The reflection type display apparatus of claim 1, wherein the image display part comprises:
a first electrode disposed on the first substrate;
a second electrode disposed on the second substrate; and
an image display layer interposed between the first electrode and the second electrode and driven by an electric field between the first electrode and the second electrode.

12. The reflection type display apparatus of claim 11, wherein the image display layer comprises an electrophoresis layer.

13. The reflection type display apparatus of claim 12, wherein the image display part further comprises a partition interposed between the first electrode and the second electrode, and
wherein the electrophoresis layer comprises:
an insulating material disposed in a space defined by the first substrate, the second substrate and the partition; and
white charged particles dispersed in the insulating material and having a first polarity; and
black charged particles dispersed in the insulating material and having a second polarity different from the first polarity,
wherein the white charged particles and the black charged particles are controlled by the electric field.

14. The reflection type display apparatus of claim 12, wherein the electrophoresis layer comprises a plurality of capsules arranged in a space defined by the first substrate, the second substrate and a partition, and
wherein each capsule of the plurality of capsules comprises:
at least one of the white charged particles and the black charged particles;
and
an insulating medium in which the at least one of the white charged particles and the black charged particles are dispersed.

15. The reflection type display apparatus of claim 12, wherein the electrophoresis layer comprises:
a continuous phase non-polar solvent; and
droplets of a polar solvent dispersed in the non-polar solvent,
wherein the droplets are controlled by the electric field.

16. The reflection type display apparatus of claim 11, wherein the image display layer comprises a liquid crystal layer.

17. The reflection type display apparatus of claim 11, wherein the image display layer comprises an electrochromic layer.

18. The reflection type display apparatus of claim 11, wherein the first electrode comprises a plurality of first sub-electrodes and the plurality of sub-electrodes corresponds to the plurality of pixel regions in a one-to-one correspondence.

19. The reflection type display apparatus of claim 18, wherein the second electrode comprises a plurality of second sub-electrodes and the plurality of second sub-electrodes corresponding to each of the plurality of first sub-electrodes.

20. The reflection type display apparatus of claim 11, wherein the first electrode comprises a metallic reflective material, and the second electrode comprises a transparent conductive material.
